(19) United States
(12) Patent Application Publication
(10) Pub. No.: US 2006/0127286 A1
(43) Pub. Date: Jun. 15, 2006

(54) Catalyst cleaning tool

(76) Inventors: James Mark Underwood, Chesterton, IN (US); Michael Joseph Underwood, Valparaiso, IN (US)

Correspondence Address: NANCY SEAR IATAROLA, 371 SPRING VIEW COURT, PORTER, IN, 46304, US

(21) Appl. No.: 11/010,717

(22) Filed: Dec. 14, 2004

(51) Int. Cl. B01D 53/34

(52) U.S. Cl. 422/178; 422/176; 422/168

(57) ABSTRACT

A device for cleaning a selective catalyst reduction unit by directing air or a cleansing solution directly into or out of honeycomb cells of the selective catalyst reduction unit. The device utilizes a plurality of orifices which are sufficient in diameter and number to cleanse honeycomb cells thereby directing air or cleansing solution into or out of each individual honeycomb cell. The device also utilizes a plurality of probes which are sufficient in number and diameter to cleanse the honeycomb cells. The invention also involves a method for cleaning the honeycomb cells and a method for producing the catalyst cleaning tool.

### REFERENCE TO MICROFICHE APPENDIX

Not Applicable.

### BACKGROUND OF THE INVENTION

1. Field of the Invention

The present invention relates generally to particulate removal from selective catalyst reduction units and more particularly to cleaning fossil fuel combustion byproducts SO_{X} and fly ash from the honeycomb cells of the selective catalyst reduction unit.

2. Description of Related Art

The EPA has recently promulgated a major reduction in nitrogen oxides (NOₓ) emissions. Predominantly coal-fired utility companies are affected by this regulation. The major method of compliance for the utilities has been use selective catalytic reduction (SCR) to reduce NOₓ emissions.

The SCR units are designed of adsorbent material in order to catch the NOₓ substances prior to entrance into the atmosphere. One type of SCR unit contains layers of adsorbent material made in honeycomb cells. Large numbers of honeycomb cells made out of ceramic or other absorbent material are used as they catch the greatest quantities of NOₓ particulate byproducts.

At some point, the SCR units become clogged with sulfur oxides (SOₓ) and/or fly ash. The greater the amount of sulfur in coal, the more frequently the SCR unit becomes clogged.

Presently, the method for removal of SOₓ and fly ash involves removal and transportation of the SCR units from the buildings housing the units. This removal and transportation utilizes a large amount of time and is very expensive.

One method in the prior art for cleaning debris like NOₓ and SOₓ involves delivering a solution of ammonia from the bottom of the SCR unit. Another method involves vacuuming the honeycomb cells of the SCR unit. Both are inefficient methods for removing SOₓ and fly ash.

Those concerned with these and other problems recognize the need for an improved method for cleaning the honeycomb cells of the SCR unit.

### BRIEF SUMMARY OF THE INVENTION

The present invention provides a device for cleaning SCR units. This invention provides an SCR cleaning tool with a plurality of spaced orifices. Air flows into the catalyst cleaning tool at the inlet, through the housing, out the plurality of spaced orifices, and is directed into the honeycomb cells. One embodiment uses a layer of polymeric material, such as rubber, to provide a tight seal between the catalyst cleaning tool and the honeycomb cells to maximize the air directed into the honeycomb cells.

Another embodiment of the invention uses a plurality of spaced probes to penetrate the honeycomb cells. The penetration physically pushes the debris out of the honeycomb cells.

A further embodiment of the invention uses a plurality of spaced orifices to pull debris out of the honeycomb cells. A vacuum pump is attached to the device and the vacuum pulls debris through the spaced orifices.

The present invention provides several advantages over the current method for cleaning which requires removal of the unit. The invention is portable and versatile. These features create an efficient and cost efficient method for cleaning debris from the honeycomb cells.

The appended drawing illustrates, by way of example, a preferred embodiment of the catalyst cleaning tool for implementing the method which is the subject of the present invention.

### BRIEF DESCRIPTION OF THE DRAWING

FIG. 1 is a perspective view of a preferred embodiment of the new catalyst cleaning tool.

1 is an embodiment of a spaced orifice
2 is an embodiment of a layer of polymeric material
3 is an embodiment of a housing
4 is an embodiment of an inlet

### DETAILED DESCRIPTION OF THE INVENTION

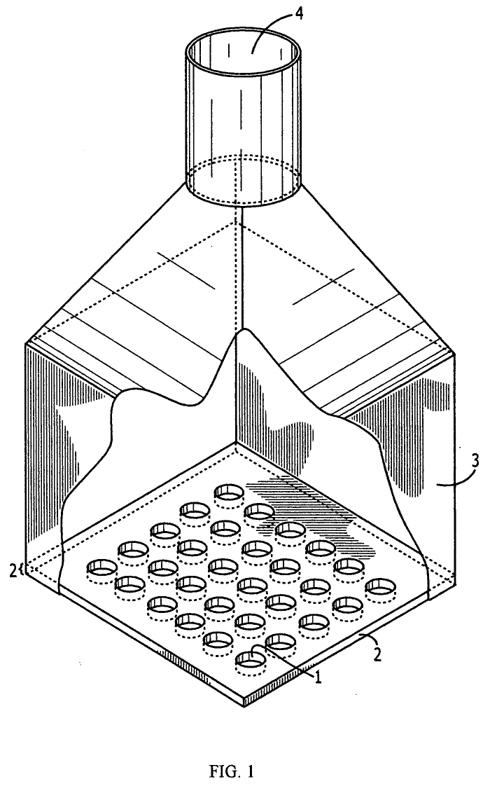

To make it possible to implement a cleaning method according to the invention, a catalyst cleaning tool as illustrated in FIG. 1 is produced which comprises an inlet 4, a housing 3, a plurality of spaced orifices 1, and a layer of polymeric material 2, the bottom of which is connected to the selective catalyst reduction unit. This layer of polymeric material 2 has a cross-sectional configuration sufficient to fit adjacent to said honeycomb cells and an outlet means comprising spaced orifices 1 for directing air through each individual honeycomb cell of the SCR. The polymeric material 2 has sufficient flexibility, resiliency, and as a result a sufficient flexural modulus to maximize the delivery of air through honeycomb cells without loss to the surroundings.

In the catalyst cleaning tool according to the invention presented in FIG. 1, the device involves a means for directing air through a plurality of spaced orifices 1 into honeycomb cells of the SCR unit. The device also involves a means for directing air out of honeycomb cells and through a plurality of spaced orifices in the device.

Preferably, the spaced orifices 1 comprise a diameter and quantity sufficient to equal to the diameter and quantity of the particular honeycomb cells it is intended to clean. The invention involves a plurality of spaced orifices 1 having a diameter and cross section sufficient to cleanse the debris in honeycomb cells of any catalyst reduction unit. The quantity of spaced orifices 1 consists of a plurality which comprises a large quantity of orifices. That large quantity or plurality may be less than the number of honeycomb cells. A still further embodiment of the invention contains a plurality of spaced orifices 1 which are greater than the number of honeycomb cells.

The diameter and/or cross section of spaced orifices 1 shown in FIG. 1 reveal spaced orifices 1 having a diameter equal to the honeycomb cell diameter. Another embodiment comprises spaced orifice 1 having a diameter greater than the diameter of the honeycomb cell of the SCR unit. Yet another embodiment comprises spaced orifices having a diameter less than the honeycomb cell diameter.

A preferred embodiment of the polymeric material 2 involves a layer of rubber containing a plurality of spaced orifices. Another embodiment of the polymeric material 2 involves carbon based polymers and/or silicone containing polymers.

An apparatus of FIG. 1 directs a flow of accelerated air through the device into the honeycomb cells. Another embodiment involves direction of a cleansing solution through the spaced orifices 1 into the honeycomb cells wherein the cleansing solution is selected from the group consisting of solids, liquids, and gases. Another embodiment involves directing a cleansing solution wherein the cleaning solution is selected from the group consisting of organic solutions, inorganic solutions, and metallic solutions.

A still further embodiment of the invention involves direction of a flow of accelerated air out of the honeycomb cells of the SCR through the spaced orifices. A method for using the device involves directing air out of the honeycomb cells of the SCR and directing air through the spaced orifices of the catalyst cleaning tool.

Another embodiment of the invention utilizes probes to clean the honeycomb cells. Rather than inserting air and/or cleaning solution the device has a plurality of probes. The probes then penetrate into the honeycomb cells and clean out the debris. The probes may be constructed of metal or other polymeric solids: carbon based, silicon based, inorganic, and/or organic compounds.

A method for cleaning honeycomb cells of a catalytic reduction unit involves attaching an air supply to the inlet 4, directing air through the plurality of spaced orifices 1, and directing air into the honeycomb cells. A further method for cleaning honeycomb cells of a selective catalytic reduction unit comprises attaching a supply of a cleansing solution to the inlet 4, directing cleansing solution through the plurality of spaced orifices 1, and directing cleansing solution into honeycomb cells of a catalytic reduction unit.

A still further method for cleaning the SCR involves directing probes into honeycomb cells of the SCR and removing debris from the SCR. A method for producing a device for cleansing an SCR comprises assembling housing, the housing having a top portion and a bottom portion, the bottom portion comprising probes, said probes for penetrating into the SCR.

A method for producing a device for cleaning honeycomb cells of a catalytic reduction unit comprises assembling a housing 3, the housing having a top portion with an inlet 4 and a bottom portion, providing spaced orifices 1 in the bottom portion, and providing a means for sealingly connecting the bottom portion to the catalytic reduction unit.

Those skilled in the art will recognize that many modifications are possible without materially departing from the novel teachings and advantages of this invention. Accordingly, all such modifications are intended to be included within the scope of this invention as defined in the following claims.

I claim:

1. A device for cleaning a selective catalyst reduction unit comprising a means for directing air through a plurality of spaced orifices into honeycomb cells of the selective catalyst reduction unit.

2. A device for cleaning a selective catalyst reduction unit comprising: a housing; said housing comprising a top portion and a bottom portion; wherein the top portion comprises an inlet; wherein the bottom portion comprises a cross-sectional configuration sufficient to fit adjacent to said honeycomb cells; the bottom portion comprises an outlet means for directing air and/or cleansing solution through each individual honeycomb cell; wherein the bottom portion further comprises means for sealingly connecting said outlet means to said selective catalytic unit.

3. An apparatus according to claim 2 wherein said means for sealingly connecting said outlet means to said selective catalytic reductive unit comprises a layer of polymeric material.

4. An apparatus according to claim 2 wherein said means for sealingly connecting said outlet means to said selective catalytic reductive unit comprises a layer of rubber attached to said bottom portion, said layer of rubber comprising a plurality of spaced orifices.

5. An apparatus of claim 2 wherein said outlet means comprises a plurality of spaced orifices.

6. An apparatus of claim 2 wherein said spaced orifices comprise a diameter sufficient to clean said honeycomb cells of said selective catalytic reductive unit.

7. A device according to claim 2 wherein the cleansing solution is selected from the group consisting of solids, liquids, and gases.

8. A device according to claim 2 wherein the cleansing solution is selected from the group consisting of organic solutions, inorganic solutions, and metallic solutions.

9. A device according to claim 2 wherein the cleaning solution is a metal probe.

10. A method for cleaning honeycomb cells of a selective catalytic reduction unit comprising attaching a supply of air and/or cleansing solution to a device for cleaning the honeycomb cells of a catalytic reduction unit and directing air and/or cleansing solution in a direction selected from a group consisting of into honeycomb cells and out of said honeycomb cells of said catalytic reduction unit through a plurality of orifices in said device.

11. A method for cleaning honeycomb cells of a catalytic reduction unit comprising attaching a supply of a cleansing solution to a device for cleaning the honeycomb cells of a catalytic reduction unit and directing said cleansing solution in a directing selected from the group consisting of into said honeycomb cells and out of said honeycomb cells through a plurality of spaced orifices orifices in said device.

12. A method for producing a device for cleaning honeycomb cells of a catalytic reduction unit comprising assembling a housing, said housing having a top portion and a bottom portion, attaching an inlet to said top portion, providing a plurality of spaced orifices in said bottom portion, and providing a means for sealingly connecting said bottom portion to said catalytic reduction unit.

13. A method for producing a device for cleaning honeycomb cells of a catalytic reduction unit comprising assembling a housing, said housing having a top portion and a bottom portion, attaching an inlet to said top portion, providing a plurality of metal probes in said bottom portion, and providing a means for inserting said probes into said selective catalytic reduction unit.

14. A method for cleaning a selective catalyst reduction unit comprising inserting a plurality of probes into said selective catalyst reduction unit.

15. A device for cleaning a selective catalyst reduction unit comprising a means for directing substances selected from the group consisting of solids, liquids, and gases through a plurality of spaced orifices and through the selective catalyst reduction unit.

16. A method for cleaning a selective catalyst reduction unit comprising directing substances selected from the group consisting of solids, liquids, and gases through a plurality of spaced orifices and directing said substances through honeycomb cells of the selective catalyst reduction unit.

17. A device for cleaning a selective catalyst reduction unit comprising a means for directing substances selected from the group consisting of solids, liquids, and gases through honeycomb cells of the selective catalyst reduction unit and through a plurality of spaced orifices.

18. A method for cleaning a selective catalyst reduction unit comprising directing substances selected from the group consisting of solids, liquids, and gases through honeycomb cells of the selective catalyst reduction unit and directing the substances selected from the group consisting of solids, liquids, and gases through a plurality of spaced orifices.
